(19) United States
(12) Patent Application Publication
(10) Pub. No.: US 2020/0123330 A1
(43) Pub. Date: Apr. 23, 2020

(54) HIGH FLEXURAL STRENGTH HIGH DENSITY ENVIRONMENTAL FRIENDLY ARTIFICIAL GLASS COMPOSITE SLAB AND THE PREPARATION METHOD THEREOF

(71) Applicant: Foshan Monica Quartz Stone Co., Ltd, Foshan (CN)

(72) Inventor: Jinpan Chen, Foshan (CN)

(73) Assignee: Foshan Monica Quartz Stone Co., Ltd, Foshan (CN)

(21) Appl. No.: 16/200,991

(22) Filed: Nov. 27, 2018

(30) Foreign Application Priority Data
Oct. 18, 2018 (CN) 201811217719.5

(51) Int. Cl. C08J 5/00; C08K 3/40; C08K 7/20; C08K 7/28; C08K 3/36; C08K 3/22; C08K 5/3417

(52) U.S. Cl. CPC C08J 5/005; C08K 3/40; C08K 7/20; C08K 7/28; C08K 3/36; C08K 3/22; B29C 43/56; C08K 2003/2227; C08K 2003/2241; C08K 2003/2272; C08K 2003/2275; C08J 2367/00; C08K 5/3417

(57) ABSTRACT

A high flexural strength high density environmental friendly artificial glass composite slab and the preparation method, spherical glass sand or spherical glass powder, filler, unsaturated resin, curing agent, coupling agent, pigment paste and toner. The glass sand or the glass powder has high hardness, good light transmittance, and a smooth surface without pores. The glass powder, filler powder and a hollow glass microspheres fill the gap among the spherical glass sand or the spherical glass powder, and mutually mesh with each other to form a high-density structure. The resulting glass composite slab has the advantages of high strength, high density, wear resistance, shining gloss and good light transmittance, while the surface is smooth and is not likely to be subjected to staining, and it is environmental friendly, non-toxic and non-radioactive.

### CROSS-REFERENCE TO RELATED APPLICATION

This application claims priority to China Patent Application No. CN 201811217719.5 filed Oct. 18, 2018 and hereby incorporated by reference in its entirety.

### TECHNICAL FIELD

The disclosure belongs to the field of artificial architectural materials, and particularly relates to a high flexural strength high density environmental friendly artificial glass composite slab and the preparation method thereof.

### BACKGROUND ART

Artificial stone slab is a new type of composite material made by mixing unsaturated polyester resin with filler and pigment, adding a small amount of initiator, and processing through a certain procedure. In the manufacturing process, different pigments can be used to make natural-marble-like products with bright colors and jade-like luster. It is non-toxic, non-radioactive, flame retardant, non-sticky, non-staining, antibacterial, mildewproof, abrasion resistant, impact resistant, easy to maintain, available for seamless splice, and can be shaped arbitrarily, so that it is gradually becoming a favorable building material in the market. When used in various commercial and entertainment places, the artificial slate can make them gorgeous and elegant with reasonable layout, and can be widely applied with perfect decorative and transmission effect, which provides you harmonious colors and make you feel warm. The special curved shape, exquisite inlay, coarse ore arch, elegant eclipse, pleasing polishment, noble and elegant Roman arch, smooth bar, harmonious and elegant commercial counter, beautiful and creative effects shows the harmony and elegance of artificial slate. For highlighting the business theme and entertainment atmosphere, the artificial slab can also be combined with a variety of materials and a variety of processing methods to create a unique design effect.

Today, as natural stone is depleted as a non-renewable resource, artificial stone has become the best alternative. Among them, artificial quartz is a representative with outstanding comprehensive performance, but quartz generally has shortcomings such as low gloss, poor light transmission, poor resistance to cracking, poor anti-staining and self-cleaning performance. Moreover, the production of high-grade quartz stone slab usually requires high-quality quartz sand. However, the country limits the exploitation of natural resources for protection of the ecological environment, leading to great restriction of mining of high-quality quartz sand. Still, many merchants are taking risks to illegally exploit high-quality quartz mines, which causes significant damages to the ecological environment. Therefore, development of a new high-grade green stone slab alternative to quartz slab meets the market demand and regulations relevant to green ecological civilization. Although glass has been used as a subsidiary raw material for artificial stone slab, it has the following disadvantages: 1. The granules are too large. Since for industry usually 2-20 mesh glass granules are used, which are easily broken, results in strength decrease of the slab and cannot be accepted by consumers; 2. the amount of glass used is generally between 5-20%, which cannot massively utilize the increasing amount of waste glass; 3. the slab lacks change and aesthetics, so that the application range is relatively narrow, and the market acceptance is bad. And artificial slab made of high-content spherical glass sand and glass powder as structural materials has not been reported.

### SUMMARY OF THE DISCLOSURE

To overcome the deficiencies and disadvantages of the prior discoveries, an object of the present disclosure is to provide a high flexural strength high density environmental friendly artificial glass composite slab and the preparation method thereof.

One embodiment of the present disclosure is achieved by the following technical solutions:

A high flexural strength high density environmental friendly artificial glass composite slab may comprise the following raw materials by mass:

| | | |
|---|---|---|
| spherical glass sand or spherical glass powder | 45-75 | parts |
| glass powder | 5-30 | parts |
| hollow glass microsphere | 2-5 | parts |
| filler | 2-25 | parts |
| unsaturated resin | 9-16 | parts |
| curing agent | 0.5-3 | parts |
| coupling agent | 0.5-2 | parts |
| pigment paste | 0.5-5 | parts |
| toner | 0.5-1.5 | parts. |

The spherical glass sand is 16-150 mesh spherical glass sand, and the spherical glass powder is 150-1500 mesh spherical glass powder.

The spherical glass sand may be selected from one or more of the group consisting of 16-30 mesh spherical glass sand, 26-40 mesh spherical glass sand, 40-70 mesh spherical glass sand, 70-120 mesh spherical glass sand and 120-150 mesh spherical glass sand; the spherical glass powder is selected from one or more of the group consisting of 150-325 mesh spherical glass powder, 325-600 mesh spherical glass powder and 600-1500 mesh spherical glass powder.

The flexural strength of said high flexural strength high density environmental friendly artificial glass composite slab is about 83-90 MPa.

The glass powder is about 250-400 mesh glass powder.

The hollow glass microsphere has a particle size of about 7-23 μm and a real density of about 0.20-0.60 g/cm³.

Said filler is at least one of quartz powder and aluminum hydroxide powder; the unsaturated resin is o-benzene, m-benzene and/or p-benzene unsaturated polyester resin; the curing agent is tert-butyl peroxy-2-ethylhexanoate; the coupling agent is γ-methacryloxypropyltrimethoxysilane.

The pigment paste is selected from one or more of the group consisting of titanium white paste, iron yellow paste, carbon black paste, bright red paste and indigo blue paste.

The toner is selected from one or more of the group consisting of titanium white powder, iron red powder, iron yellow powder, iron black powder, indigo blue powder, metal powder and carbon black powder.

An exemplary preparation method of the high flexural strength high density environmental friendly artificial glass composite slab according to claim 1, may comprise the following steps:

(1) stirring about 0.5-3 parts by mass of the curing agent, about 0.5-2 parts by mass of the coupling agent, about 0.5-5 parts by mass of the pigment paste and about 9-16 parts by mass of the unsaturated resin and mixing them uniformly to obtain a premix;

(2) blending the premix obtained in step (1) with about 45-75 parts by mass of the spherical glass sand or the spherical glass powder, about 5-30 parts by mass of the glass powder, about 2-5 parts by mass of the hollow glass microsphere, and about 2-25 parts by mass of the filler powder for about 10 min, wherein the blending comprises forward rotation at about 15 Hz for 2 min, reverse rotation at about 15 Hz for 2 min, forward rotation at about 45 Hz for 3 min and reverse rotation at about 45 Hz for 3 min;

(3) spreading the product of step (2) on a mold pad, and spraying about 0.5-1.5 parts by mass of the toner according to a certain grain design;

(4) transferring the product of step (3) to a vacuum press, vacuumizing it for vibration compression molding, and then transferring the product to a curing oven for curing at about 75-90° C. for 90-150 min, wherein the step of vibration compression molding comprises about 25 Hz for 40 s, 30 Hz for 30 s, 36 Hz for 30 s, 40 Hz for 30 s, 44 Hz for 60 s, 50 Hz for 30 s sequentially;

(5) demolding the obtained intermediate slab, vertically shaping for about 24 h, fixing the thickness, polishing, inspecting and packaging to obtain a final product.

The present disclosure has the following advantages and effects over prior technologies:

The disclosure uses glass sand and glass powder as main raw materials, wherein the spherical glass sand or the spherical glass powder has high hardness, good light transmittance, and smooth surface without pores; the glass powder, a small amount of quartz powder or aluminum hydrogen powder and the hollow glass microspheres fill the gap among the spherical glass sand or the spherical glass powder, and mutually mesh with each other to form a high-density structure; the spherical glass microspheres are easy to move, and the filling density is easily increased during the vibration process, thus the amount of resin is reduced; o-benzene, m-benzene and p-benzene unsaturated resin are used for cross-linking and bonding, and the obtained artificial glass composite slab has the advantages of high strength, high density, wear resistance, shining gloss and good light transmittance, while the surface is smooth and not likely to be subjected to staining, and it is environmental friendly, non-toxic and non-radioactive.

The present disclosure blends evenly the raw materials by rotation with different frequencies, which comprises forward rotation at about 15 Hz for 2 min, reverse rotation at about 15 Hz for 2 min, forward rotation at about 45 Hz for 3 min and reverse rotation at about 45 Hz for 3 min. Also, with a reasonable ratio of different raw materials, a highest filling density is achieved, the mixing of the raw materials is more uniform, and the bonding of the resin and the solid raw materials is better.

3. To overcome the disadvantages of excess vibration rate of traditional vibration machine, the vibration frequency is divided into about 8 frequency bands, including about 25 Hz for 40 s, 30 Hz for 30 s, 36 Hz for 30 s, 40 Hz for 30 s, 44 Hz for 60 s, 50 Hz for 30 s; the present disclosure carries out vibration compression with different frequencies under vacuum condition, and in order to solve the problem that bubble and cavities are easily generated, about 2-5% hollow glass microspheres are introduced. The glass microspheres move easily during the vibration process, so as to fill the bubble and cavities to achieve higher density, reduce surface pores, and achieve better anti-staining and self-cleaning performance.

There are various resources of glass sand and glass powder. After breaking the glass scraps, they can be reused, which meets the requirements of green ecological civilization construction and waste recycling advocated by the country, and makes the earth cleaner.

The product of the disclosure can be applied with different colors, can be produced on a large scale, and can be produced according to the specific requirements of the customer. It is also convenient for decoration, and can provide a high-grade multi-colored living space.

### BRIEF DESCRIPTION OF THE DRAWINGS

FIG. 1 shows the flow of a production process according to the preparation method of the artificial glass composite slab of the present disclosure;

FIG. 2 is a cross-sectional view of a conventional quartz stone; and

FIG. 3 is a cross-sectional view of the artificial glass composite slab of the present disclosure.

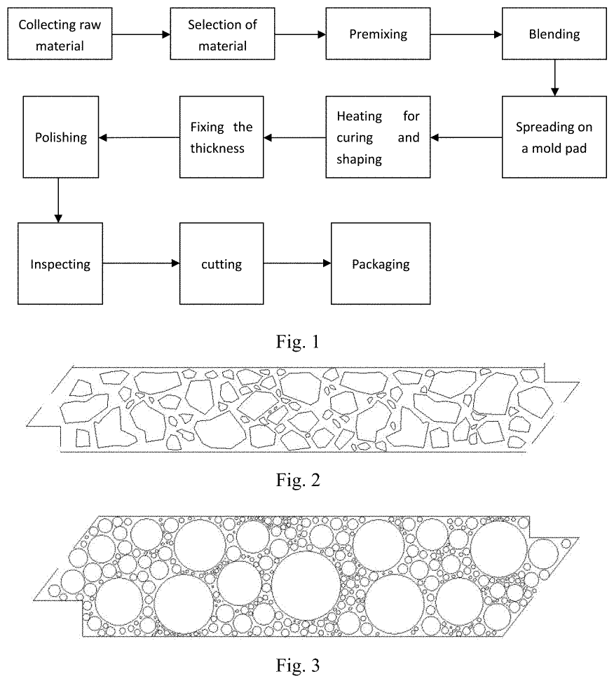

### DETAILED DESCRIPTION OF THE EMBODIMENTS

The present disclosure will be further described in detail below with reference to the FIG. 3 embodiments, but the embodiments of the present disclosure are not limited thereto. Three examples are provided. It will be appreciated that these examples may be modified to include more or few materials and steps of manufacturing.

### Example 1

A high flexural strength high density environmental friendly artificial glass composite slab 10, comprising the following raw materials by mass:

| | |
|---|---|
| spherical glass sand or spherical glass powder | 60 parts |
| glass powder | 12 parts |
| hollow glass microsphere | 3 parts |
| filler powder | 5 parts |
| unsaturated resin | 12.5 parts |
| tert-butyl peroxy-2-ethylhexanoate | 2.2 parts |
| γ-methacryloxypropyltrimethoxysilane | 1.3 parts |
| composite pigment paste | 3.5 parts |
| composite toner | 0.5 parts. |

Wherein, the spherical glass sand may be obtained by mixing 26-40 mesh spherical glass sand, 40-70 mesh spherical glass sand and 70-120 mesh spherical glass sand in a mass ratio of 2:3:1. It can be seen from the cross-sectional view of the artificial glass composite slab 10 shown in FIG. 3 that when the glass sand 12 contained is regularly spherical, the glass sand 12 is evenly distributed, so that the composite slab 10 has a large overall structural density 14 and higher flexural strength. By contrast, as shown in FIG. 2, which is a cross-sectional view of a conventional quartz stone slab 20, the shape of the particles 22 is different, and thus the composite slab 20 will have an uneven internal distribution 24, loose structure, and low overall flexural strength.

The glass powder is about 300 mesh glass powder.

The hollow glass microspheres are about 600 mesh hollow glass microspheres; bubble holes are easily generated during vacuuming, and the glass microspheres move easily during the vibration process, so as to fill the bubble and cavities to achieve higher density, reduce surface pores, and achieve better anti-staining and self-cleaning performance; meantime the amount of resin is reduced.

The filler powder is obtained by mixing quartz powder and aluminum hydroxide powder according to a mass ratio of about 1:3.

The composite pigment paste is obtained by mixing titanium white paste, bright red paste and iron yellow paste according to a mass ratio of 9:1:3.

The toner is obtained by mixing titanium white powder, iron red powder and indigo blue powder according to a mass ratio of about 3:1:5.

In the present example, the preparation method of the high flexural strength high density environmental friendly artificial glass composite slab 20 may comprise one or more of the following steps:

(1) weighting each raw material according to the mentioned formula;

(2) blending: adding the composite pigment paste, the unsaturated resin, tert-butyl peroxy-2-ethylhexanoate and γ-methacryloxypropyltrimethoxysilane to a resin mixing vessel and stirring uniformly, then spreading them into a blander containing the premixed spherical glass sand, glass powder, hollow glass microspheres and filler powder, and blending them for about 10 min, wherein the blending may comprise forward rotation at 15 Hz for 2 min, reverse rotation at 15 Hz for 2 min, forward rotation at 45 Hz for 3 min and reverse rotation at 45 Hz for 3 min;

(3) toner spraying: spreading the mixed material of step (2) on a mold pad, flattening the material, spraying the composite toner, and flipping the material;

(4) vacuum compression: transferring the toner sprayed product obtained in step (3) to a vacuum compression machine with the mold pad, vacuumizing it and conducting vibration compression molding, which may comprise about 25 Hz for 40 s, 30 Hz for 30 s, 36 Hz for 30 s, 40 Hz for 30 s, 44 Hz for 60 s, 50 Hz for 30 s sequentially; the stepwise vibration can effectively overcome the disadvantages of excess vibration rate of traditional vibration machine;

(5) curing: then transferring the compressed slab to a curing oven for curing at about 75° C. for 150 min, and shaping vertically for about 24 h; and

(6) fixing the thickness and polishing: transferring the intermediate slab to a polishing machine for thickness fixing, and conduct precise polishing with 26-6000 mesh grinding block to obtain the high flexural strength high density environmental friendly artificial glass composite slab.

An alternative traditional artificial glass composite slab 10 is further disclosed. Here, the raw materials and the preparation steps are the same as above except that the spherical glass sand is replaced by 2-15 mesh large-size irregular glass sand.

The mechanical properties of the obtained high flexural strength high density environmental friendly artificial glass composite slab 10 and the traditional artificial glass composite slab 20 have been tested. The three results of the flexural strength test of the traditional artificial glass composite slab 20 are 49.3 Mpa, 49.5 Mpa and 49.4 Mpa respectively with an average of 49.4 Mpa; the three results of the flexural strength test of high flexural strength high density environmental friendly artificial glass composite slab 10 are 84.5, 85.0, and 84.8 Mpa respectively with an average of 84.7 Mpa, which is 70% higher than that of the traditional artificial glass composite slab. In addition, the high flexural strength high density environmental friendly artificial glass composite slab 10 is subjected to ball impact strength test for three times, and the results are 116, 120, and 118 cm respectively with an average of 118 cm.

### Example 2

An alternative flexural strength high density environmental friendly artificial glass composite slab 10, may comprise the following raw materials by mass:

| | |
|---|---|
| spherical glass sand or spherical glass powder | 55 parts |
| glass powder | 10 parts |
| hollow glass microsphere | 4 parts |
| filler powder | 12 parts |
| unsaturated resin | 11 parts |
| tert-butyl peroxy-2-ethylhexanoate | 1.8 parts |
| γ-methacryloxypropyltrimethoxysilane | 1.2 parts |
| composite pigment paste | 3.8 parts |
| composite toner | 1.2 parts. |

Wherein, the spherical glass sand may be obtained by mixing 26-40 mesh spherical glass sand, 40-70 mesh spherical glass sand and 70-120 mesh spherical glass sand in a mass ratio of 1:3:2.

The glass powder is about 250 mesh glass powder.

The hollow glass microspheres are about 800 mesh hollow glass microspheres.

The filler powder is obtained by mixing quartz powder and aluminum hydroxide powder according to a mass ratio of about 6:5.

The composite pigment paste is obtained by mixing titanium white paste, iron red paste and iron black paste according to a mass ratio of about 1:1:4.

The toner is obtained by mixing titanium white powder, iron yellow powder and metal powder according to a mass ratio of about 4:3:1.

In the present example, the preparation method of the high flexural strength high density environmental friendly artificial glass composite slab 10 may comprise one or more of the following steps:

(1) weighting each raw material according to the mentioned formula;

(2) blending: adding the composite pigment paste, the unsaturated resin, tert-butyl peroxy-2-ethylhexanoate and γ-methacryloxypropyltrimethoxysilane to a resin mixing vessel and stirring uniformly, then spreading them into a blander containing the premixed spherical glass sand, glass powder, hollow glass microspheres and filler powder, and blending them for 10 min, wherein the blending may comprise forward rotation at 15 Hz for 2 min, reverse rotation at 15 Hz for 2 min, forward rotation at 45 Hz for 3 min and reverse rotation at 45 Hz for 3 min;

(3) toner spraying: spreading the mixed material of step (2) on a mold pad, flattening the material, spraying the composite toner, and compressing the material;

(4) vacuum compression: transferring the toner sprayed product obtained in step (3) to a vacuum compression machine with the mold pad, vacuumizing it and conducting vibration compression molding, which may comprise 25 Hz for 40 s, 30 Hz for 30 s, 36 Hz for 30 s, 40 Hz for 30 s, 44 Hz for 60 s, 50 Hz for 30 s sequentially;

(5) curing: then transferring the compressed slab to a curing oven for curing at about 85° C. for 130 min, and shaping vertically for about 24 h;

(6) fixing the thickness and polishing: transferring the intermediate slab to a polishing machine for thickness fixing, and conduct precise polishing with about a 26-6000 mesh grinding block to obtain the high flexural strength high density environmental friendly artificial glass composite slab.

An artificial glass composite slab is further prepared, wherein the raw materials and the preparation steps are the same as above except that the spherical glass sand is replaced by about 2-15 mesh large-size irregular glass sand.

The mechanical properties of the obtained high flexural strength high density environmental friendly artificial glass composite slab 10 and the traditional artificial glass composite slab 20 are tested. The three results of the flexural strength test of the traditional artificial glass composite slab are 48.4 Mpa, 48.9 Mpa and 49.8 Mpa respectively with an average of 49.0 Mpa; the three results of the flexural strength test of high flexural strength high density environmental friendly artificial glass composite slab are 84.6, 84.4, and 84.1 Mpa respectively with an average of 84.4 Mpa, which is 70% higher than that of the traditional artificial glass composite slab. In addition, the high flexural strength high density environmental friendly artificial glass composite slab is subjected to ball impact strength test for three times, and the results are 122, 126, and 123 cm respectively with an average of 124 cm.

### Example 3

An alternative high flexural strength high density environmental friendly artificial glass composite slab 10, may comprise the following raw materials by mass: spherical glass sand or spherical glass powder 50 parts

| | |
|---|---|
| glass powder | 10 parts |
| hollow glass microsphere | 5 parts |
| filler powder | 15 parts |
| unsaturated resin | 13 parts |
| tert-butyl peroxy-2-ethylhexanoate | 1.5 parts |
| γ-methacryloxypropyltrimethoxysilane | 1 parts |
| composite pigment paste | 4 parts |
| composite toner | 0.5 parts. |

Wherein, the spherical glass sand may be obtained by mixing about 16-30 mesh spherical glass sand, about 26-40 mesh spherical glass sand and about 40-70 mesh spherical glass sand in a mass ratio of 1:2:5.

The glass powder is about 400 mesh glass powder.

The hollow glass microspheres are 1000 mesh hollow glass microspheres.

The filler powder is obtained by mixing quartz powder and aluminum hydroxide powder according to a mass ratio of about 1:3.

The composite pigment paste is obtained by mixing titanium white paste, bright red paste and iron yellow paste according to a mass ratio of about 9:1:3.

The toner is obtained by mixing titanium white powder, iron red powder and indigo blue powder according to a mass ratio of about 3:1:5.

In the present example, the preparation method of the high flexural strength high density environmental friendly artificial glass composite slab 10 may comprise one or more of the following steps:

(1) weighting each raw material according to the mentioned formula;

(2) blending: adding the composite pigment paste, the unsaturated resin, tert-butyl peroxy-2-ethylhexanoate and γ-methacryloxypropyltrimethoxysilane to a resin mixing vessel and stirring uniformly, then spreading them into a blander containing the premixed spherical glass sand, glass powder, hollow glass microspheres and filler powder, and blending them for 10 min, wherein the blending may comprise forward rotation at about 15 Hz for 2 min, reverse rotation at about 15 Hz for 2 min, forward rotation at about 45 Hz for 3 min and reverse rotation at about 45 Hz for 3 min;

(3) toner spraying: spreading the mixed material of step (2) on a mold pad, flattening the material, spraying the composite toner, stacking the material, spraying the composite toner again and flipping the material;

(4) vacuum compression: transferring the toner sprayed product obtained in step (3) to a vacuum compression machine with the mold pad, vacuumizing it and conducting vibration compression molding, which comprises about 25 Hz for 40 s, 30 Hz for 30 s, 36 Hz for 30 s, 40 Hz for 30 s, 44 Hz for 60 s, 50 Hz for 30 s sequentially;

(5) curing: then transferring the compressed slab to a curing oven for curing at about 90° C. for 120 min, and shaping vertically for about 24 h;

(6) fixing the thickness and polishing: transferring the intermediate slab to a polishing machine for thickness fixing, and conduct precise polishing with about 26-6000 mesh grinding block to obtain the high flexural strength high density environmental friendly artificial glass composite slab.

A traditional artificial glass composite slab is further prepared, wherein the raw materials and the preparation steps are the same as above except that the spherical glass sand is replaced by about 2-15 mesh large-size irregular glass sand.

The mechanical properties of the obtained high flexural strength high density environmental friendly artificial glass composite slab 10 and the traditional artificial glass composite slab have been tested. The three results of the flexural strength test of the traditional artificial glass composite slab are 49.6 Mpa, 50.1 Mpa and 49.4 Mpa respectively with an average of 49.7 Mpa. The three results of the flexural strength test of high flexural strength high density environmental friendly artificial glass composite slab 10 are 85.8, 85.4, and 85.5 Mpa respectively with an average of 85.6 Mpa, which is 70% higher than that of the traditional artificial glass composite slab 20. In addition, the high flexural strength high density environmental friendly artificial glass composite slab 10 is subjected to ball impact strength test for three times, and the results are 125, 121, and 122 cm respectively with an average of 123 cm.

The above described embodiments are exemplary embodiments of the present disclosure, but the embodiments of the present disclosure are not limited to the above described embodiments. Any other changes, modifications, substitutions, combinations, and simplifications made without departing from the spirit and scope of the disclosure should be equivalent replacements and be included in the scope of the present disclosure.

What is claimed is:

1. A high flexural strength high density environmental friendly artificial glass composite slab, comprising the following raw materials by mass:

| | | |
|---|---|---|
| spherical glass sand or spherical glass powder | 45-75 | parts |
| glass powder | 5-30 | parts |
| hollow glass microsphere | 2-5 | parts |
| filler | 2-25 | parts |
| unsaturated resin | 9-16 | parts |
| curing agent | 0.5-3 | parts |
| coupling agent | 0.5-2 | parts |
| pigment paste | 0.5-5 | parts |
| toner | 0.5-1.5 | parts. |

2. The high flexural strength high density environmental friendly artificial glass composite slab according to claim 1, wherein the spherical glass sand is 16-150 mesh spherical glass sand, and the spherical glass powder is 150-1500 mesh spherical glass powder.

3. The high flexural strength high density environmental friendly artificial glass composite slab according to claim 2, wherein the spherical glass sand is selected from one or more of the group consisting of 16-30 mesh spherical glass sand, 26-40 mesh spherical glass sand, 40-70 mesh spherical glass sand, 70-120 mesh spherical glass sand and 120-150 mesh spherical glass sand; the spherical glass powder is selected from one or more of the group consisting of 150-325 mesh spherical glass powder, 325-600 mesh spherical glass powder and 600-1500 mesh spherical glass powder.

4. The high flexural strength high density environmental friendly artificial glass composite slab according to claim 1, wherein the flexural strength of said high flexural strength high density environmental friendly artificial glass composite slab is 83-90 MPa.

5. The high flexural strength high density environmental friendly artificial glass composite slab according to claim 1, wherein the glass powder is 250-400 mesh glass powder.

6. The high flexural strength high density environmental friendly artificial glass composite slab according to claim 1, wherein the hollow glass microsphere has a particle size of 7-23 μm and a real density of 0.20-0.60 g/cm³.

7. The high flexural strength high density environmental friendly artificial glass composite slab according to claim 1, wherein said filler is at least one of quartz powder and aluminum hydroxide powder; the unsaturated resin is o-benzene, in-benzene and/or p-benzene unsaturated polyester resin; the curing agent is tert-butyl peroxy-2-ethylhexanoate; and the coupling agent is γ-methacryloxypropyltrimethoxysilane.

8. The high flexural strength high density environmental friendly artificial glass composite slab according to claim 1, wherein the pigment paste is selected from one or more of the group consisting of titanium white paste, iron yellow paste, carbon black paste, bright red paste and indigo blue paste.

9. The high flexural strength high density environmental friendly artificial glass composite slab according to claim 1, wherein the toner is selected from one or more of the group consisting of titanium white powder, iron red powder, iron yellow powder, iron black powder, indigo blue powder, metal powder and carbon black powder.

10. A preparation method of the high flexural strength high density environmental friendly artificial glass composite slab comprising the following steps:
(1) stirring 0.5-3 parts by mass of a curing agent, 0.5-2 parts by mass of a coupling agent, 0.5-5 parts by mass of a pigment paste and 9-16 parts by mass of an unsaturated resin and mixing them uniformly to obtain a premix;
(2) blending the premix obtained in step (1) with 45-75 parts by mass of a spherical glass sand or a spherical glass powder, 5-30 parts by mass of the glass powder, 2-5 parts by mass of a hollow glass microsphere, and 2-25 parts by mass of a filler powder for 10 min, wherein the blending comprises forward rotation at 15 Hz for 2 min, reverse rotation at 15 Hz for 2 min, forward rotation at 45 Hz for 3 min and reverse rotation at 45 Hz for 3 min;
(3) spreading a product of step (2) on a mold pad, and spraying 0.5-1.5 parts by mass of a toner according to a certain grain design;
(4) transferring a product of step (3) to a vacuum press, vacuumizing it for vibration compression molding, and then transferring the product to a curing oven for curing at 75-90° C. for 90-150 min, wherein the step of vibration compression molding comprises 25 Hz for 40 s, 30 Hz for 30 s, 36 Hz for 30 s, 40 Hz for 30 s, 44 Hz for 60 s, 50 Hz for 30 s sequentially; and
(5) demolding an obtained intermediate slab, vertically shaping for 24 h, fixing the thickness, polishing, inspecting and packaging to obtain a final product.

11. A preparation method of the high, flexural strength high density environmental friendly artificial glass composite slab comprising:
(1) stirring a curing agent, a coupling agent, a pigment paste of an unsaturated resin and mixing them uniformly to obtain a premix;
(2) blending the premix obtained in step (1) with one of a spherical glass sand and a spherical glass powder, a hollow glass microsphere, and a filler powder for about 10 min, wherein the blending step comprises at least one of forward rotation at about 15 Hz for 2 min, reverse rotation at about 15 Hz for 2 mm, forward rotation at about 45 Hz for 3 min and reverse rotation at about 45 Hz for 3 min;
(3) spreading a product of step (2) on a mold pad, aid spraying a toner according to a certain grain design;
(4) transferring a product of step (3) to a vacuum press, vacuumizing it for vibration compression molding, and then transferring the product to a curing oven wherein the step of vibration compression molding comprises at least one of about 25 Hz for 40 s, 30 Hz for 30 s, 36 Hz for 30 s, 40 Hz for 30 s, 44 Hz for 60 s, 50 Hz for 30 s sequentially; and
(5) demolding an obtained intermediate slab, vertically shaping for a period.
